(19) United States
(12) Patent Application Publication
(10) Pub. No.: US 2026/0064455 A1
(43) Pub. Date: Mar. 5, 2026

(54) VIRTUAL MACHINE SCHEDULING METHOD, MEDIUM, AND ELECTRONIC DEVICE

(71) Applicant: Beijing Volcano Engine Technology Co., Ltd., Beijing (CN)

(72) Inventors: Zhaoyunfei LI, Beijing (CN); Fuxin JIANG, Beijing (CN)

(21) Appl. No.: 19/225,880

(22) Filed: Jun. 2, 2025

(30) Foreign Application Priority Data
Sep. 5, 2024 (CN) 202411246873.0

(51) Int. Cl. G06F 9/455; G06F 9/48

(52) U.S. Cl. CPC G06F 9/45558; G06F 9/45541; G06F 9/4856; G06F 2009/4557

(57) ABSTRACT

The present disclosure relates to a virtual machine scheduling method, a medium, and an electronic device, and relates to the field of computer technologies. The virtual machine scheduling requirement is converted into a target constraint condition through resource information of a target virtual machine and a target physical machine, and a target virtual machine migration path is determined according to the target constraint condition, the resource information of the target virtual machine and the target physical machine, and a basic scheduling algorithm. The virtual machine scheduling is performed according to the target virtual machine migration path.

### CROSS-REFERENCE TO RELATED APPLICATION

The present application claims the priority of the Chinese patent application 202411246873.0 filed on Sep. 5, 2024, the entire contents of which are hereby incorporated by reference as a part of the present application.

### TECHNICAL FIELD

The present disclosure relates to the field of computer technologies and, in particular, to a virtual machine scheduling method, a medium, and an electronic device.

### BACKGROUND

Scheduling of a virtual machine includes primary scheduling and secondary scheduling. The primary scheduling is intended to allocate a suitable physical machine to a newly created virtual machine, and the secondary scheduling is intended to optimize resource usage and improve system performance. In the related art, the secondary scheduling of the virtual machine is generally implemented through a scheduling algorithm. However, the underlying scheduling algorithm is strongly coupled with the virtual machine scheduling requirement. Once the virtual machine scheduling requirement changes, the underlying scheduling algorithm also needs to be adjusted accordingly, resulting in increased costs and reduced flexibility of the secondary scheduling of the virtual machine.

### SUMMARY

This Summary is provided to introduce concepts in a simplified form that are described in detail in the following Detailed Description section. This Summary is not intended to identify key or essential features of the claimed technical solutions, nor is it intended to be used to limit the scope of the claimed technical solutions.

In a first aspect, the present disclosure provides a virtual machine scheduling method, including:
determining resource information of a target virtual machine and a target physical machine indicated by a virtual machine scheduling requirement in response to the virtual machine scheduling requirement;
converting the virtual machine scheduling requirement into a target constraint condition of the target virtual machine and the target physical machine under a basic scheduling algorithm according to a conversion rule that is pre-configured, wherein the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirement, virtual machine migration paths corresponding to the virtual machine scheduling requirement, and the conversion rule is generated based on a historical virtual machine scheduling requirement and is used to convert different types of virtual machine scheduling requirements into different constraint conditions;
determining a target virtual machine migration path corresponding to the virtual machine scheduling requirement according to the target constraint condition, the resource information of the target virtual machine and the target physical machine, and the basic scheduling algorithm; and
performing virtual machine scheduling according to the target virtual machine migration path.

In a second aspect, the present disclosure provides a virtual machine scheduling apparatus, including:
a first determination module, configured to determine resource information of a target virtual machine and a target physical machine indicated by a virtual machine scheduling requirement in response to the virtual machine scheduling requirement;
a conversion module, configured to convert the virtual machine scheduling requirement into a target constraint condition of the target virtual machine and the target physical machine under a basic scheduling algorithm according to a conversion rule that is pre-configured, wherein the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirements, virtual machine migration paths corresponding to the virtual machine scheduling requirements, and the conversion rule is generated based on a historical virtual machine scheduling requirement and is used to convert different types of virtual machine scheduling requirements into different constraint conditions;
a second determination module, configured to determine a target virtual machine migration path corresponding to the virtual machine scheduling requirement according to the target constraint condition, the resource information of the target virtual machine and the target physical machine, and the basic scheduling algorithm; and
an execution module, configured to perform virtual machine scheduling according to the target virtual machine migration path.

In a third aspect, the present disclosure provides a computer-readable medium having a computer program stored thereon, where the computer program, when executed by a processing apparatus, implements the steps of the method according to the first aspect.

In a fourth aspect, the present disclosure provides an electronic device, including:
a storage apparatus having a computer program stored thereon; and
a processing apparatus configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

Other features and advantages of the present disclosure will be described in detail in the following Detailed Description section.

### BRIEF DESCRIPTION OF DRAWINGS

The above and other features, advantages and aspects of the embodiments of the present disclosure will become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale. In the drawings:

FIG. 1 is a flowchart of a virtual machine scheduling method according to some embodiments.

FIG. 2 is a schematic diagram of a target constraint condition according to some embodiments.

FIG. 3 is a schematic diagram of virtual machine scheduling according to some embodiments.

FIG. 4 is a schematic diagram of virtual machine scheduling according to yet some embodiments.

FIG. 5 is a structural diagram of a virtual machine scheduling apparatus according to an exemplary embodiment.

FIG. 6 is a structural diagram of an electronic device according to an exemplary embodiment.

### DETAILED DESCRIPTION

The embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the protection scope of the present disclosure.

It should be understood that various steps recited in method implementations of the present disclosure may be performed in a different order and/or in parallel. Additionally, the method implementations may include additional steps and/or omit performing illustrated steps. The scope of the present disclosure is not limited in this respect.

As used herein, the term “include/comprise” and its variants are open-ended inclusions, that is, “include/comprise but not limited to”. The term “based on” is “based at least in part on”. The term “one embodiment” means “at least one embodiment”. The term “another embodiment” means “at least one additional embodiment”. The term “some embodiments” means “at least some embodiments”. Relevant definitions of other terms will be given in the following description.

It is to be noted that concepts such as “first” and “second” mentioned in the present disclosure are only used to distinguish between different apparatuses, modules or units, and are not used to limit the order or interdependence of the functions performed by these apparatuses, modules or units.

It is to be noted that modifications of “one” and “a plurality” mentioned in the present disclosure are illustrative and not restrictive, and those skilled in the art should understand that they should be construed as “one or more” unless the context clearly indicates otherwise.

The names of messages or information exchanged between a plurality of apparatuses in the implementations of the present disclosure are only for illustrative purposes, and are not intended to limit the scope of these messages or information.

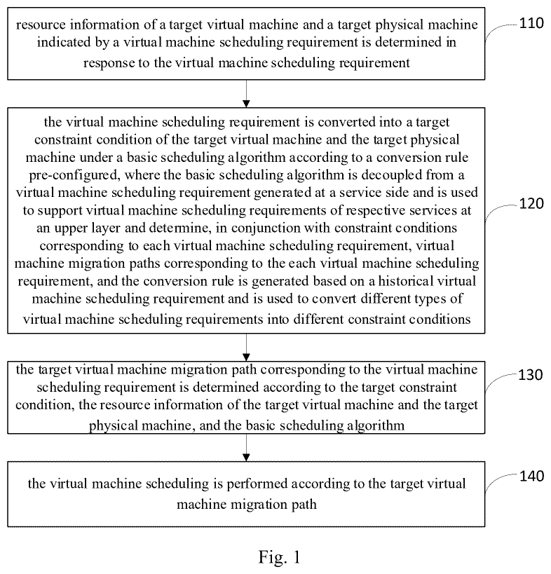

FIG. 1 is a flowchart of a virtual machine scheduling method according to some embodiments. As shown in FIG. 1, an embodiment of the present disclosure provides a virtual machine scheduling method, the method may be performed by an electronic device, and in particular, may be performed by a virtual machine scheduling apparatus, which may be implemented in software and/or hardware and configured in the electronic device. As shown in FIG. 1, the method may include the following steps.

In step 110, resource information of a target virtual machine and a target physical machine indicated by a virtual machine scheduling requirement is determined in response to the virtual machine scheduling requirement.

Here, the virtual machine scheduling requirement may be a requirement for scheduling the virtual machine configured by the user to achieve specific service objectives and performance requirements.

Exemplarily, the virtual machine scheduling requirement may include a dispersion requirement, an evacuation requirement, a defragmentation requirement, an inventory relocation requirement or the like. The dispersion requirement is used to indicate that virtual machines are spread across different physical machines; the evacuation requirement is used to indicate that all virtual machines are migrated from a certain physical machine; the defragmentation requirement is used to optimize a storage layout of the virtual machines on the physical machine so as to reduce fragmentation of storage space; and the inventory relocation requirement is used to indicate that the allocation of virtual machines is reorganized or adjusted to optimize resource usage.

It should be noted that the user may configure the corresponding virtual machine scheduling requirement through a configuration interface provided by an electronic device.

The target virtual machine and the target physical machine indicated by the virtual machine scheduling requirement refer to the virtual machine and the physical machine that need to be scheduled for the virtual machine scheduling requirement.

The resource information of the target virtual machine includes resource usage information of the target virtual machine and a distribution relationship of the target virtual machine on the target physical machine. The resource usage information is computing resources required for the target virtual machine to run, such as memory, storage, network bandwidth, and CPU (Central Processing Unit) resources. The resource information of the target physical machine includes resource provisioning information of the target physical machine, and the resource provisioning information is resources that can be currently provided by the target virtual machine.

It should be understood that for each target virtual machine and target physical machine in a cloud service system, both the target virtual machine and the target physical machine have unique identifiers corresponding to them.

It should be noted that the target virtual machine for the virtual machine scheduling requirement may refer to a virtual machine that has been deployed in the cloud service system. In other words, the virtual machine scheduling method provided in the embodiments of the present disclosure is applicable to secondary scheduling of an existing virtual machine. Certainly, the virtual machine scheduling method provided in the embodiments of the present disclosure is also applicable to secondary scheduling of a virtual machine that a customer has not purchased but plans to purchase, which will be described in detail in subsequent embodiments.

In step 120, the virtual machine scheduling requirement is converted into a target constraint condition of the target virtual machine and the target physical machine under a basic scheduling algorithm according to a conversion rule that is pre-configured, where the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirement, virtual machine migration paths corresponding to the virtual machine scheduling requirement, and the conversion rule is generated based on a historical virtual machine scheduling requirement and is used to convert different types of virtual machine scheduling requirements into different constraint conditions.

Here, the target constraint condition of the target virtual machine and the target physical machine under the basic scheduling algorithm includes a target constraint condition of the target virtual machine, a target constraint condition of the target physical machine, a target constraint condition between target virtual machines, and a target constraint condition between the target virtual machine and the target physical machine.

For different virtual machine scheduling requirements, the conversion rule converts different virtual machine scheduling requirements into the target constraint conditions of the target virtual machine and the target physical machine under the basic scheduling algorithm, thereby implementing constraining a migration manner of the target virtual machine through the virtual machine scheduling requirement.

It should be noted that different types of virtual machine scheduling requirements correspond to different constraint conditions under the same basic scheduling algorithm. The conversion rule is generated based on the historical virtual machine scheduling requirement and is used to convert different types of virtual machine scheduling requirements into different constraint conditions. The historical virtual machine scheduling requirement refers to a virtual machine scheduling requirement generated in history. For different historical virtual machine scheduling requirements, the historical virtual machine scheduling requirement may be abstracted into a corresponding constraint condition. When the new virtual machine scheduling requirement is consistent with the historical virtual machine scheduling requirement, the constraint condition corresponding to the new virtual machine scheduling requirement is consistent with the constraint condition corresponding to the historical virtual machine scheduling requirement.

Assuming that the scheduling objective of the basic scheduling algorithm is to minimize the affinity coefficient of the virtual machine migration path, different affinity coefficients are configured between the target virtual machines and between the target virtual machine and the target physical machine according to different virtual machine scheduling requirements. For example, if the virtual machine scheduling requirement indicates that virtual machine A and virtual machine B should not be deployed on the same physical machine as much as possible, the affinity coefficient between virtual machine A and virtual machine B may be set to be relatively large.

In the related art, for different virtual machine scheduling requirements, scheduling objectives used may be inconsistent to obtain a virtual machine migration path matching with a virtual machine scheduling requirement. In order to obtain virtual machine migration paths corresponding to different virtual machine scheduling requirements, the scheduling objective of the basic scheduling algorithm needs to be changed, thereby requiring improvements to the underlying of the basic scheduling algorithm. However, in the embodiments of the present disclosure, for different virtual machine scheduling requirements, the same basic scheduling algorithm is used to calculate the virtual machine migration paths corresponding to different virtual machine scheduling requirements. For example, for virtual machine scheduling requirements such as the dispersion requirement, the evacuation requirement, the defragmentation requirement, the inventory relocation requirement, etc., the corresponding virtual machine migration paths are calculated by the scheduling objective under the same basic scheduling algorithm.

In other words, the conversion rule is actually used to translate the virtual machine scheduling requirement into the target constraint condition of the target virtual machine and the target physical machine under the basic scheduling algorithm, thereby influencing the virtual machine migration path finally determined by the basic scheduling algorithm through the target constraint condition, so that the virtual machine migration path can fulfill the virtual machine scheduling requirement, instead of influencing the finally determined virtual machine migration path by adjusting the scheduling objective of the basic scheduling algorithm through the virtual machine scheduling requirement.

Therefore, the basic scheduling algorithm is decoupled from the virtual machine scheduling requirement generated at the service side, and cannot be adjusted differently due to different virtual machine scheduling requirements generated at the service side. The basic scheduling algorithm is configured to support the virtual machine scheduling requirements of the respective services at the upper layer and determine, in conjunction with the constraint conditions corresponding to respective virtual machine scheduling requirement, the virtual machine migration paths corresponding to virtual machine scheduling requirements. That is, the basic scheduling algorithm can determine the virtual machine migration path corresponding to the virtual machine scheduling requirement through the constraint condition corresponding to the virtual machine scheduling requirement without adjustment.

In the embodiments of the present disclosure, by converting the virtual machine scheduling requirement into the constraint condition of the target virtual machine and the target physical machine under the basic scheduling algorithm, decoupling between the virtual machine scheduling requirement can be achieved, and there is no need to adjust the underlying logic and the scheduling objective of the basic scheduling algorithm according to different virtual machine scheduling requirements. Instead, the virtual machine scheduling requirement is converted into the target constraint condition of the target virtual machine and the target physical machine under the basic scheduling algorithm through the conversion rule, thereby influencing the virtual machine migration path calculated by the basic scheduling algorithm through the target constraint condition, so that the basic scheduling algorithm searches for the virtual machine migration path that meets the virtual machine scheduling requirement in the direction of the virtual machine scheduling requirement.

In step 130, the target virtual machine migration path corresponding to the virtual machine scheduling requirement is determined according to the target constraint condition, the resource information of the target virtual machine and the target physical machine, and the basic scheduling algorithm.

Here, the scheduling problem of the virtual machine is similar to the optimization objective of the bin packing problem, both of which are to find a suitable bin (equivalent to a physical machine) for an object (equivalent to a virtual machine) under certain conditions. Therefore, the basic scheduling algorithm may be a general bin packing algorithm, and the bin packing algorithm determines the target virtual machine migration path corresponding to the virtual machine scheduling requirement according to the target constraint condition, the resource information of the target virtual machine and the target physical machine.

It should be understood that the scheduling objective corresponding to the virtual machine scheduling requirement is actually abstracted into the scheduling objective in the bin packing algorithm, and the scheduling rule in the virtual machine scheduling requirement is converted into the target constraint condition in the bin packing algorithm, thereby implementing the calculation of the target virtual machine migration paths that meet different virtual machine scheduling requirements using the general bin packing algorithm.

The target virtual machine migration path may be a virtual machine migration sequence, and the virtual machine migration sequence includes virtual machine migration paths corresponding to at least one target virtual machine that the virtual machine scheduling requirement is directed to. A start point of any virtual machine migration path is a source physical machine, and a terminal of the virtual machine migration path is a destination physical machine.

It should be understood that the resource information of the target virtual machine and the target physical machine is used to constrain the target virtual machine migration path calculated by the basic scheduling algorithm. The target virtual machine migration path that meets minimizing the scheduling objective of the basic scheduling algorithm needs to enable each corresponding target virtual machine to obtain required computing resources. That is, the resource provisioning information of the destination physical machine of the target virtual machine migration path can match with the resource usage information of the virtual machine migrated to the destination physical machine.

In step 140, the virtual machine scheduling is performed according to the target virtual machine migration path.

Here, after the target virtual machine migration path is determined, the target virtual machine migration path is executed, so as to migrate the target virtual machine to the destination physical machine indicated by the target virtual machine migration path. For example, if the target virtual machine migration path indicates that the virtual machine A migrates from the physical machine B to the physical machine C, the target virtual machine migration path is executed, so as to migrate the virtual machine A to the physical machine C.

It should be understood that the target virtual machine migration path may include a path indicating that there is no need to perform migration, and for this path, the corresponding virtual machine is still deployed on the corresponding physical machine.

Therefore, by determining the resource information of the target virtual machine and the target physical machine indicated by the virtual machine scheduling requirement, converting the virtual machine scheduling requirement into the target constraint condition of the target virtual machine and the target physical machine under the basic scheduling algorithm according to the conversion rule, then determining the target virtual machine migration path corresponding to the virtual machine scheduling requirement according to the target constraint condition, the resource information of the target virtual machine and the target physical machine, and the basic scheduling algorithm, and performing the virtual machine scheduling according to the target virtual machine migration path, the virtual machine scheduling requirement can be converted into the target constraint condition of the basic scheduling algorithm, thereby implementing decoupling between the virtual machine scheduling requirement and the basic scheduling algorithm, so that the virtual machine scheduling requirement is not limited by the underlying scheduling algorithm, flexible adjustment of the virtual machine scheduling requirement can be supported, and the flexible and changeable virtual machine scheduling requirement can be adapted by adjusting the conversion rule, to obtain an accurate global optimal solution for the virtual machine scheduling, thereby greatly reducing the cost of the virtual machine scheduling.

In some possible implementations, the target constraint condition includes at least one of a first affinity coefficient or a second affinity coefficient, the first affinity coefficient is used to represent magnitude of an affinity relationship between virtual machines, and the second affinity coefficient is used to represent magnitude of an affinity relationship between a virtual machine and a physical machine.

Here, the affinity relationship between the virtual machine and the physical machine and the affinity relationship between the virtual machines refers to that scheduling objects with an affinity relationship should be preferentially scheduled to positions close to each other. For example, a virtual machine has an affinity relationship with another virtual machine that executes its dependent service.

The magnitude of the affinity relationship is represented by the magnitude of the affinity coefficient. That is, for different virtual machine scheduling requirements, the conversion rule converts the virtual machine scheduling requirement into the first affinity coefficient between different target virtual machines and/or the second affinity coefficient between the target virtual machine and the target physical machine.

It should be noted that the affinity relationship between the target virtual machines refers to an association relationship in which some virtual machines are configured to preferentially run on the same physical machine according to specific service requirements in the cloud service system. The affinity relationship between the virtual machine and the physical machine refers to a priority scheduling or running relationship that the virtual machine tends to establish with a specific physical machine according to a specific service requirement in the cloud service system.

It should be noted that the affinity relationship is related to the virtual machine scheduling requirement, and for different virtual machine scheduling requirements, there are different affinity relationships between the target virtual machines and between the target virtual machine and the target physical machine. For example, if the virtual machine scheduling requirement indicates that the virtual machine A and the virtual machine B can be deployed on the same physical machine, there is an affinity relationship between the virtual machine A and the virtual machine B. According to the strength of the tendency that the virtual machine A and the virtual machine B can be deployed on the same physical machine indicated by the virtual machine scheduling requirement, the magnitude of the affinity relationship between the virtual machine A and the virtual machine B may also be different, which is represented by the magnitude of the affinity coefficient.

Therefore, the magnitudes of the first affinity coefficient and the second affinity coefficient are related to the virtual machine scheduling requirement and the scheduling objective corresponding to the basic scheduling algorithm.

Exemplarily, if the scheduling objective of the basic scheduling algorithm is to minimize the sum of the affinity coefficients corresponding to the target virtual machine migration path, and if the virtual machine scheduling requirement indicates that the virtual machine A and the virtual machine B should not be deployed on the same physical machine as much as possible, the first affinity coefficient between the virtual machine A and the virtual machine B is relatively large, so that the target virtual machine migration path determined by the basic scheduling algorithm can prevent the virtual machine A and the virtual machine B from being deployed on the same physical machine as much as possible. If the virtual machine scheduling requirement indicates that the virtual machine A and the virtual machine B should be deployed on the same physical machine as much as possible, the second affinity coefficient between the virtual machine A and the virtual machine B is relatively small, so that the target virtual machine migration path determined by the basic scheduling algorithm can enable the virtual machine A and the virtual machine B to be deployed on the same physical machine. Certainly, if the scheduling objective of the basic scheduling algorithm is to maximize the sum of the affinity coefficients corresponding to the target virtual machine migration path, and if the virtual machine scheduling requirement indicates that the virtual machine A and the virtual machine B should not be deployed on the same physical machine as much as possible, the first affinity coefficient between the virtual machine A and the virtual machine B is relatively small, so that the target virtual machine migration path determined by the basic scheduling algorithm can prevent the virtual machine A and the virtual machine B from being deployed on the same physical machine as much as possible.

In other words, in the embodiments of the present disclosure, the virtual machine scheduling requirement is represented as the corresponding first affinity coefficient and/or second affinity coefficient through the conversion rule, so that the basic scheduling algorithm adjusts the optimization direction of the virtual machine scheduling through the first affinity coefficient and/or the second affinity coefficient.

In some embodiments, the conversion rule includes a scheduling relationship definition rule, and the scheduling relationship definition rule may match the target virtual machine and the target virtual machine with the corresponding first affinity coefficients and match the target virtual machine and the target physical machine with the corresponding second affinity coefficients according to different virtual machine scheduling requirements, so as to constrain the migration manner of the virtual machines through the first affinity coefficient and the second affinity coefficient.

Accordingly, in step 130, the target virtual machine migration path that meets minimizing the scheduling objective corresponding to the basic scheduling algorithm may be determined according to the target constraint condition, the resource information, and the basic scheduling algorithm, the scheduling objective being to minimize the sum of the affinity coefficients corresponding to the target virtual machine migration path.

Here, after the virtual machine scheduling requirement is converted into the first affinity coefficient and/or the second affinity coefficient through the conversion rule, the basic scheduling algorithm may be used to determine the target virtual machine migration path that meets minimizing the scheduling objective of the basic scheduling algorithm according to the resource information of the target virtual machine and the target physical machine, the first affinity coefficient, and/or the second affinity coefficient, and the target virtual machine migration path is the virtual machine migration path that meets the virtual machine scheduling requirement.

The scheduling objective corresponding to the basic scheduling algorithm is used to minimize the sum of the affinity coefficients corresponding to the target virtual machine migration path. When calculating the virtual machine migration path, the basic scheduling algorithm determines, according to the resource information of the target virtual machine and the target physical machine, which physical machine respective virtual machine can be scheduled to, and determines, through the magnitude of the first affinity coefficient and/or the second affinity coefficient, the virtual machine migration path that can minimize the sum of the affinity coefficients corresponding to the target virtual machine migration path.

It should be noted that in the embodiments of the present disclosure, for different virtual machine scheduling requirements, the target virtual machine migration paths corresponding to different virtual machine scheduling requirements is calculated by the same scheduling objective of the same basic scheduling algorithm. By converting the virtual machine scheduling requirement into the first affinity coefficient and/or the second affinity coefficient of the target virtual machine and the target physical machine under the basic scheduling algorithm through the conversion rule, the bin packing algorithm can perform bin packing judgment based on the first affinity coefficient and/or the second affinity coefficient, thereby defining an overall optimization direction of the bin packing algorithm under the scheduling objective, to obtain the target virtual machine migration path that meets the virtual machine scheduling requirement.

Therefore, through the above implementations, different virtual machine scheduling requirements can be converted into different first affinity coefficients and/or second affinity coefficients, to influence the target virtual machine migration path obtained through the basic scheduling algorithm through the first affinity coefficient and/or the second affinity coefficient, thereby implementing decoupling between the virtual machine scheduling requirement and the basic scheduling algorithm and greatly reducing the cost of the virtual machine scheduling.

In some possible implementations, the target constraint condition further includes at least one of the followings:
a mutual exclusion relationship between target virtual machines;
a mutual exclusion relationship between the target virtual machine and the target physical machine, where the mutual exclusion relationship is used to indicate that the basic scheduling algorithm excludes a virtual machine migration path with the mutual exclusion relationship;
an attribute type of the target virtual machine and an attribute type of the target physical machine, where the attribute type is used to indicate that the basic scheduling algorithm selects a virtual machine migration path where the target virtual machine and the target physical machine both having consistent attribute types are deployed together as the target virtual machine migration path; or
a scheduling overhead of the target virtual machine and a scheduling overhead of the target physical machine, where the scheduling overhead is used to indicate that the basic scheduling algorithm determines the target virtual machine migration path that meets minimizing the scheduling objective corresponding to the basic scheduling algorithm, and the scheduling objective is to minimize the sum of the scheduling overheads of the target virtual machine migration path and to minimize the sum of the affinity coefficients of the target virtual machine migration path.

Here, the mutual exclusion relationship means that some virtual machines should not be scheduled to the same physical resource to avoid resource contention or violation of specific service rules. For example, if the virtual machine scheduling requirement indicates that the virtual machine A and the virtual machine B cannot be deployed on the same physical machine, there is a mutual exclusion relationship between the virtual machine A and the virtual machine B. For another example, if the virtual machine scheduling requirement indicates that the virtual machine A cannot be deployed on the physical machine C, there is a mutual exclusion relationship between the virtual machine A and the physical machine C.

Through the mutual exclusion relationship, it can be determined that the virtual machine cannot be scheduled to the physical machine with the mutual exclusion relationship with the virtual machine, and through the mutual exclusion relationship, it can be determined that the virtual machines with the mutual exclusion relationship cannot be deployed on the same physical machine.

Through the mutual exclusion relationship between the virtual machines and the mutual exclusion relationship between the virtual machine and the physical machine, the basic scheduling algorithm can be caused to exclude the virtual machine migration path with the mutual exclusion relationship, so that the obtained target virtual machine migration path does not have the virtual machine migration path with the mutual exclusion relationship.

It should be understood that the conversion rule may include the scheduling relationship definition rule, and the scheduling relationship definition rule may match the target virtual machine and the target physical machine with the corresponding mutual exclusion relationship according to different virtual machine scheduling requirements, so as to constrain the migration manner of the virtual machines through the mutual exclusion relationship.

The attribute type of the target virtual machine and the attribute type of the target physical machine, as a constraint for the virtual machine scheduling, are used to prohibit the target virtual machine from being deployed on the target physical machine with an attribute type inconsistent with the attribute type of the target virtual machine.

Exemplarily, different attribute types of the target physical machine represent that the target physical machine can deploy target virtual machines with corresponding attribute types. Accordingly, when calculating the target virtual machine migration path, the basic scheduling algorithm may constrain the target virtual machine migration path finally calculated by the basic scheduling algorithm through the attribute types of the target virtual machine and the target physical machine.

It should be noted that the attribute type of the target virtual machine and the attribute type of the target physical machine are determined by the virtual machine scheduling requirement, and for different virtual machine scheduling requirements, the target virtual machine and the target physical machine may have different attribute types.

The conversion rule may include a scheduling object attribute definition rule, and the scheduling object attribute definition rule classifies the target virtual machine and the target physical machine according to different virtual machine scheduling requirements, and assigns the attribute types corresponding to the virtual machine scheduling requirement to the target virtual machine and the target physical machine, so as to constrain the migration manner of the virtual machines through the attribute type of the target virtual machine and the attribute type of the target physical machine.

Through the attribute type, the basic scheduling algorithm can be caused to select, when calculating the target virtual machine migration path, the virtual machine migration path where the virtual machine and the physical machine with consistent attribute types are deployed together as the target virtual machine migration path. Alternatively, through the attribute type, the basic scheduling algorithm can be caused to, when calculating the target virtual machine migration path, prohibit selecting the virtual machine migration path where the target virtual machine is deployed on the target physical machine with the attribute type inconsistent with the attribute type of the target virtual machine.

In some embodiments, the first affinity coefficient and the second affinity coefficient may be related to the attribute type. For example, the first affinity coefficient and the second affinity coefficient may be determined by a preset calculation formula, where the preset calculation formula is:

mixCost=F(itemAttr,boxAttr)
where mixCost is the second affinity coefficient, itemAttr is the attribute type of the target virtual machine, boxAttr is the attribute type of the target physical machine, and F is a function.

The scheduling overhead of the target virtual machine (which may also be referred to as a migration overhead of the target virtual machine) refers to the costs and performance impacts that need to be borne when the target virtual machine is migrated from one physical machine to another physical machine. For different virtual machine scheduling requirements, each target virtual machine may have different scheduling overheads. The scheduling overhead is used to constrain the scheduling priority of the target virtual machine, and the scheduling priority of the target virtual machine is negatively correlated with the magnitude of the scheduling overhead. That is, the greater the scheduling overhead of the target virtual machine, the lower the scheduling priority of the corresponding target virtual machine.

For example, if the virtual machine scheduling requirement requires that the virtual machine A should not be migrated as much as possible, the value of the scheduling overhead of the virtual machine A is set to be relatively large through the conversion rule. Accordingly, when calculating the target virtual machine migration path through the scheduling objective, the basic scheduling algorithm may not preferentially schedule the virtual machine A, but preferentially schedule the target virtual machine with a smaller scheduling overhead.

The conversion rule may include the scheduling object attribute definition rule, and the scheduling object attribute definition rule may match the target virtual machine with the corresponding scheduling overhead according to different virtual machine scheduling requirements, so as to constrain the migration manner of the virtual machines through the scheduling overhead of the target virtual machine.

The scheduling overhead of the target physical machine refers to the costs and resource consumption generated in the running and maintenance process of the target physical machine. For different virtual machine scheduling requirements, each target physical machine may have different scheduling overheads. The scheduling overhead of the target physical machine is used to constrain the usage priority of the target physical machine, and the usage priority of the target physical machine is negatively correlated with the magnitude of the scheduling overhead of the target physical machine. That is, the greater the scheduling overhead of the target physical machine, the lower the usage priority of the corresponding target physical machine.

For example, if the virtual machine scheduling requirement requires that the physical machine A should not be used to deploy the virtual machine as much as possible, the value of the scheduling overhead of the physical machine A is set to be relatively large through the conversion rule. Accordingly, when calculating the target virtual machine migration path through the scheduling objective, the basic scheduling algorithm may not preferentially use the target physical machine A, but preferentially use the target physical machine with a smaller scheduling overhead.

The conversion rule may include the scheduling object attribute definition rule, and the scheduling object attribute definition rule may match the target physical machine with the corresponding scheduling overhead according to different virtual machine scheduling requirements, so as to constrain the migration manner of the virtual machines through the scheduling overhead of the target physical machine.

Accordingly, in step 130, the target virtual machine migration path that meets minimizing the scheduling objective corresponding to the basic scheduling algorithm may be determined according to the scheduling overhead of the target virtual machine, the scheduling overhead of the target physical machine, the first affinity coefficient, the second affinity coefficient, the resource information, and the basic scheduling algorithm. The scheduling objective is to minimize the sum of the scheduling overheads of the target virtual machine migration path and to minimize the sum of the affinity coefficients of the target virtual machine migration path.

It should be noted that when the target constraint condition includes the scheduling overhead of the target virtual machine and the scheduling overhead of the target physical machine, the basic scheduling algorithm can minimize the sum of the scheduling overheads corresponding to the target virtual machine migration path while minimizing the sum of the affinity coefficients of the target virtual machine migration path.

Through the attribute type, the scheduling overhead, the mutual exclusion relationship, the first affinity coefficient, and the second affinity coefficient, the virtual machine scheduling requirement can be represented from multiple dimensions, so that the virtual machine scheduling can achieve an optimal resource distribution from a global perspective.

It should be understood that for different virtual machine scheduling requirements, different types of virtual machine scheduling requirements can be converted into the scheduling overhead, the mutual exclusion relationship, the first affinity coefficient, and the second affinity coefficient under the same basic scheduling algorithm only by setting different conversion rules, so that not only can the flexible and changeable virtual machine scheduling requirements be directly represented through the conversion rule, but also the decoupling between the virtual machine scheduling requirement and the basic scheduling algorithm can be implemented.

Therefore, the conversion rule represents a mapping relationship between the constraint condition and the scheduling objective of the basic scheduling algorithm. Through the conversion rule, the virtual machine scheduling requirement can be converted into the input of the basic scheduling algorithm, and different virtual machine scheduling requirements can be converted into the corresponding target constraint conditions, so as to adjust the optimization direction of the virtual machine migration path, thereby implementing the decoupling between the virtual machine scheduling requirement and the basic scheduling algorithm.

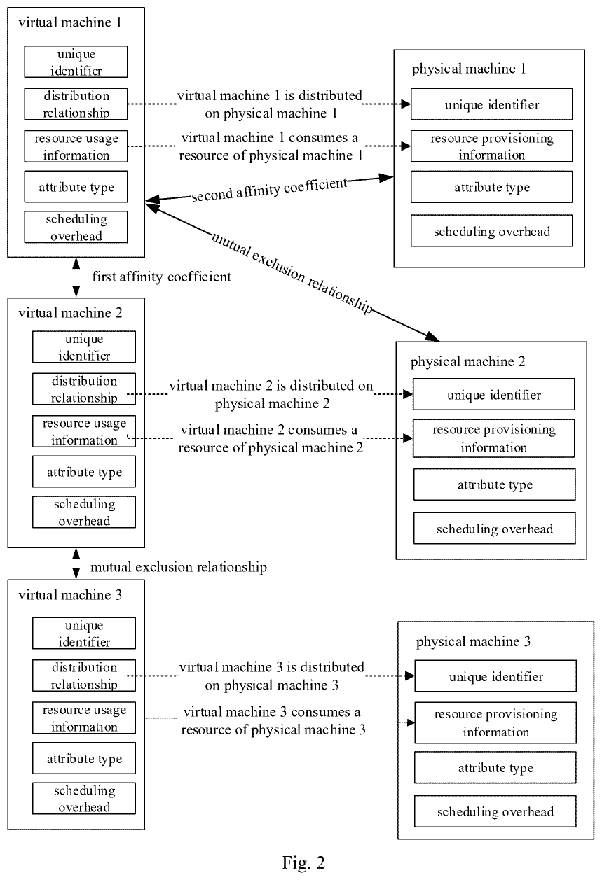

FIG. 2 is a schematic diagram of a target constraint condition according to some embodiments. As shown in FIG. 2, each virtual machine has its corresponding resource information (including a unique identification, a distribution relationship, and resource usage information), and each physical machine has its corresponding resource information (including a unique identification and resource provisioning information). The virtual machine 1 is distributed on the physical machine 1, the virtual machine 2 is distributed on the physical machine 2, and the virtual machine 3 is distributed on the physical machine 3. The virtual machine 1 consumes resources of the physical machine 1, the virtual machine 2 consumes resources of the physical machine 2, and the virtual machine 3 consumes resources of the physical machine 3.

Through the conversion rule, the virtual machine scheduling requirement is converted into the attribute type of the target virtual machine, the scheduling overhead of the target virtual machine, the attribute type of the target physical machine, the scheduling overhead of the target physical machine, the second affinity coefficient between the target virtual machine and the target physical machine, and the first affinity coefficient between the target virtual machines.

For example, as shown in FIG. 2, under the virtual machine scheduling requirement, there is an affinity relationship between the virtual machine 1 and the virtual machine 2, which has a corresponding first affinity coefficient, and there is a mutual exclusion relationship between the virtual machine 2 and the virtual machine 3. There is an affinity relationship between the virtual machine 1 and the physical machine 1, which has a corresponding second affinity coefficient, and there is a mutual exclusion relationship between the virtual machine 1 and the physical machine 2. Additionally, assuming that the virtual machine 1 is migrated from the physical machine 1 to the physical machine 3, the sum of the scheduling overheads is the sum of the scheduling overhead of the virtual machine 1 and the scheduling overhead of the virtual machine 3.

Therefore, through the conversion rule, the virtual machine scheduling requirement can be converted into the attribute type of the target virtual machine, the scheduling overhead of the target virtual machine, the attribute type of the target physical machine, the scheduling overhead of the target physical machine, the second affinity coefficient between the target virtual machine and the target physical machine, and the first affinity coefficient between the target virtual machine and the target virtual machine, thereby converting the virtual machine scheduling requirement into the target constraint condition, implementing converting the virtual machine scheduling requirement into the input of the basic scheduling algorithm, and thus implementing the secondary scheduling of the virtual machine without changing the basic scheduling algorithm. When the virtual machine scheduling requirement changes, it is only necessary to use the corresponding conversion rule to convert the changed virtual machine scheduling requirement into the corresponding target constraint condition, so that the virtual machine scheduling can be quickly implemented for the flexible and changeable virtual machine scheduling requirement.

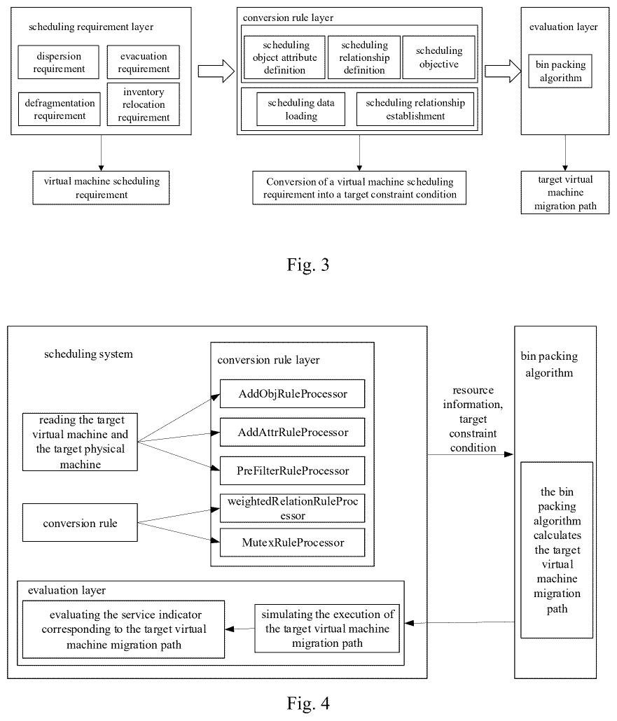

FIG. 3 is a schematic diagram of virtual machine scheduling according to some embodiments. As shown in FIG. 3, the corresponding virtual machine scheduling requirement is configured in a scheduling requirement layer, and the virtual machine scheduling requirement is converted into the target constraint condition by a conversion rule layer through scheduling object attribute definition, scheduling relationship definition, and a preset scheduling objective. Then, data such as the resource information and the target constraint condition is transferred to a computing layer through modules for scheduling data loading and scheduling relationship establishment, and the computing layer calculates the target virtual machine migration path corresponding to the virtual machine scheduling requirement by the bin packing algorithm.

In some possible implementations, the conversion rule includes different matching conditions and constraint conditions associated with the matching conditions, the matching conditions are determined according to parameters included in the historical virtual machine scheduling requirement, and the constraint conditions associated with the matching conditions are determined according to a scheduling objective corresponding to the historical virtual machine scheduling requirement. Accordingly, in step 120, the target parameter included in the virtual machine scheduling requirement may be matched through the different matching conditions, and the constraint condition associated with the target matching condition is determined as the target constraint condition according to the target matching condition matched to the target parameter.

Here, the conversion rule may include a plurality of rules. For example, the conversion rule may include the scheduling relationship definition rule and the scheduling object attribute definition rule. Each conversion rule has a corresponding matching condition and a constraint condition associated with the matching condition. The matching condition corresponding to each conversion rule may be determined according to the parameter included in the historical virtual machine scheduling requirement, and the constraint condition associated with each matching condition is determined according to the scheduling objective corresponding to the historical virtual machine scheduling requirement.

In other words, the corresponding matching condition and the constraint condition that can fulfill the scheduling objective corresponding to the historical virtual machine scheduling requirement are abstracted from the historical virtual machine scheduling requirement, to obtain the matching condition and the constraint condition associated with the matching condition corresponding to the historical virtual machine scheduling requirement.

It should be understood that the target parameter includes a parameter used to describe the migration manner of the target virtual machine. For example, if the virtual machine scheduling requirement indicates that the virtual machine A and the virtual machine B cannot be deployed on the same physical machine, the fact that the virtual machine A and the virtual machine B cannot be deployed on the same physical machine may be the corresponding target parameter.

In some embodiments, the virtual machine scheduling requirement may be configured through a configuration channel that is provided. The configuration channel supports the user to configure the virtual machine scheduling requirement through a number of configuration manners including parameter configuration, option configuration, semantic configuration, or visual configuration.

The configuration channel may be a configuration interface for configuring the virtual machine scheduling requirement, and the configuration interface may include one or more configuration manners, so that the user configures the virtual machine scheduling requirement through the one or more configuration manners provided by the configuration interface.

The configuration manner of parameter configuration is used to enable the user to configure the virtual machine scheduling requirement through a parameter item pre-configured for defining the migration manner of the virtual machine. For example, the configuration interface may receive a specific parameter input by the user to generate the corresponding virtual machine scheduling requirement.

The configuration manner of option configuration is used to enable the user to configure the virtual machine scheduling requirement through a pre-configured option. For example, the configuration channel includes options for describing the dispersion requirement, the evacuation requirement, the defragmentation requirement, and the inventory relocation requirement, and the user can select one or more options according to requirements through the configuration channel to generate the corresponding virtual machine scheduling requirement.

The configuration manner of semantic configuration is used to enable the user to configure the virtual machine scheduling requirement through a natural language. For example, the user can input a natural language “the virtual machine A and the virtual machine B should not be deployed on the same physical machine as much as possible” through the configuration channel to configure and generate the virtual machine scheduling requirement.

The configuration manner of visual configuration is used to enable the user to configure the virtual machine scheduling requirement through a visual operation. For example, in the configuration interface, the user can configure the virtual machine scheduling requirement through visual operations such as dragging a position of the virtual machine and establishing a relationship between the virtual machine and the physical machine through connection.

It should be understood that after the user finishes configuring the virtual machine scheduling requirement through the configuration channel, the virtual machine scheduling is triggered, and the virtual machine scheduling method provided in the embodiments of the present disclosure is executed to obtain the target virtual machine migration path corresponding to the virtual machine scheduling requirement.

Exemplarily, in the embodiments of the present disclosure, the conversion rule may be loaded through a parser, and the corresponding matching conditions and the associated constraint conditions may be obtained by parsing the conversion rule. Then, the parser matches the parameters included in the virtual machine scheduling requirement through the different matching conditions, determines the target matching condition that the virtual machine scheduling requirement hits, and determines the constraint condition associated with the target matching condition that is hit as the target constraint condition, thereby converting the virtual machine scheduling requirement into the constraint condition of the basic scheduling algorithm.

It should be noted that for different virtual machine scheduling requirements, the corresponding conversion rules may be configured for them, thereby implementing the conversion of different virtual machine scheduling requirements into the corresponding target constraint conditions.

Therefore, through the above implementations, the virtual machine scheduling requirement can be quickly converted into the corresponding target constraint condition, and when the virtual machine scheduling requirement changes, the virtual machine scheduling can be implemented only by adjusting the conversion rule, without adjusting the basic scheduling algorithm.

In some possible implementations, in step 110, a test virtual machine and a test physical machine matching with a target number indicated by the virtual machine scheduling requirement may be created according to the virtual machine scheduling requirement; corresponding resource information is configured for the test virtual machine and the test physical machine according to the virtual machine scheduling requirement; and the resource information of the test virtual machine and the test physical machine is used as the resource information of the target virtual machine and the target physical machine indicated by the virtual machine scheduling requirement.

Here, in the virtual machine scheduling, not only existing virtual machines and physical machines can be scheduled, but also virtual machines and physical machines that have not been created can be scheduled in a simulated manner, to test whether the cloud service system can bear the requirements of the virtual machines and physical machines that have not been created corresponding to the virtual machine scheduling requirement. For example, in some scenarios, the user has not purchased a virtual machine yet, but the number of virtual machines that the user needs to purchase and the type of the virtual machines that the user needs to purchase are known through the virtual machine scheduling requirement. Then, the test virtual machine and the test physical machine matching with the target number indicated by the virtual machine scheduling requirement may be created according to the virtual machine scheduling requirement, and the corresponding resource information may be configured for the test virtual machine and the test physical machine according to the virtual machine scheduling requirement. For another example, in some scenarios, the virtual machine scheduling requirement represents that the user plans to newly deploy a virtual machine. Since the newly added virtual machine does not exist in the cloud service system, the virtual machine resources and physical machine resources in the cloud service system cannot meet the scheduling objective corresponding to the virtual machine scheduling requirement. Then, the corresponding test virtual machine and test physical machine may be created to perform the virtual machine scheduling for the virtual machine originally owned by the user, the physical machine originally owned by the cloud service system, and the created test virtual machine and test physical machine, thereby testing whether the cloud service system can fulfill the scheduling objective corresponding to the virtual machine scheduling requirement.

The resource information corresponding to the test virtual machine and the test physical machine is related to the virtual machine scheduling requirement, and for different virtual machine scheduling requirements, the resource information of the created test virtual machine and test physical machine may be different. It should be understood that the meaning of the resource information of the test virtual machine and the test physical machine is consistent with the meaning of the target virtual machine and the target physical machine in the above embodiments, which will not be repeated here.

Exemplarily, trough the scheduling object definition rule, resource information corresponding to the test virtual machines and test physical machines that match the virtual machine scheduling requirements may be configured according to the virtual machine scheduling requirement.

It should be noted that the test virtual machine and the test physical machine are not real virtual machines and physical machines, but test virtual machines and test physical machines defined according to the virtual machine scheduling requirement and used to simulate the virtual machine scheduling requirement.

Therefore, by creating the test virtual machine and the test physical machine, the virtual machines and physical machines that do not exist can be simulated and calculated, thereby solving the problem in the related virtual machine scheduling technology that only the real scheduling objects can be scheduled, and ensuring that the test virtual machine and the test physical machine can meet the target constraint condition of the basic scheduling algorithm, thereby improving the stability and accuracy of resource calculation. For example, in some scenarios, the existing resources in the cloud service system cannot fulfill the scheduling objective corresponding to the virtual machine scheduling requirement, and the virtual machine resources and physical machine resources need to be supplemented. However, the supplemented virtual machine resources and physical machine resources need to be scheduled and tested. If the scheduling test is only performed from the existing virtual machine resources and physical machine resources gap, there may be a problem that the existing virtual machine resources and physical machine resources have not been reallocated, and the resource gap obtained by directly performing the virtual machine scheduling calculation is not the optimal solution. Moreover, if the virtual machine scheduling is only performed for the existing resources, the constraint of the virtual machine scheduling requirement cannot be fulfilled, resulting in the final calculated target virtual machine migration path being unavailable. By creating the test virtual machine and the test physical machine, the newly added and undeployed virtual machines and physical machines can be subjected to secondary scheduling, to obtain a more accurate virtual machine migration path and resource gap.

In some possible implementations, in step 140, a service indicator of the cloud service system corresponding to the target virtual machine when the target virtual machine migration path is executed may be predicted according to the target virtual machine migration path, and the virtual machine scheduling is performed according to the target virtual machine migration path in case that the service indicator meets a preset condition.

Here, after the target virtual machine migration path is obtained, the execution of the target virtual machine migration path may be simulated, to predict the service indicator of the cloud service system when the target virtual machine migration path is executed. The service indicator refers to a series of key performance indicators used to measure performance, efficiency, cost, and user satisfaction. For example, the service indicator may include indicators such as migration time, performance impact, resource utilization, service outage time, and cost effectiveness.

When the service indicator meets the preset condition, the target virtual machine migration path is actually executed, so as to migrate the virtual machine.

It should be understood that the preset condition may be set according to requirements. For example, when the migration time is less than a preset time, it is determined that the service indicator meets the preset condition.

Therefore, through the above implementations, the target virtual machine migration path may be executed to migrate the virtual machine when the service indicator corresponding to the target virtual machine migration path meets the preset condition, so as to ensure the stability of the cloud service system.

FIG. 4 is a schematic diagram of virtual machine scheduling according to yet some embodiments. As shown in FIG. 4, a scheduling system receives a virtual machine scheduling requirement and reads the target virtual machine and the target physical machine indicated by the virtual machine scheduling requirement. The scheduling system creates the test virtual machine and the test physical machine through the AddObjRuleProcessor (scheduling object definition rule) of the conversion rule layer, defines the attribute types and the scheduling overheads of the target virtual machine and the target physical machine through the AddAttrRuleProcessor (scheduling object attribute definition rule), and filters the target virtual machine and the target physical machine that do not need to be scheduled through the PreFilterRuleProcessor (pre-filter rule). Additionally, the scheduling system defines the first affinity coefficient and the second affinity coefficient of the target virtual machine and the target physical machine through the weightedRelationRuleProcessor (scheduling relationship definition rule) of the conversion rule layer, and defines the mutual exclusion relationship between the target virtual machine and the target physical machine through the MutexRuleProcessor (scheduling relationship definition rule).

Then, the scheduling system inputs the resource information of the target virtual machine and the target physical machine and the target constraint condition into the bin packing algorithm, the bin packing algorithm calculates the target virtual machine migration path based on the resource information and the target constraint condition, and returns the target virtual machine migration path to the scheduling system. The scheduling system simulates the execution of the target virtual machine migration path through an evaluation layer, and evaluates the service indicator corresponding to the target virtual machine migration path, to determine whether to execute the target virtual machine migration path to migrate the virtual machine.

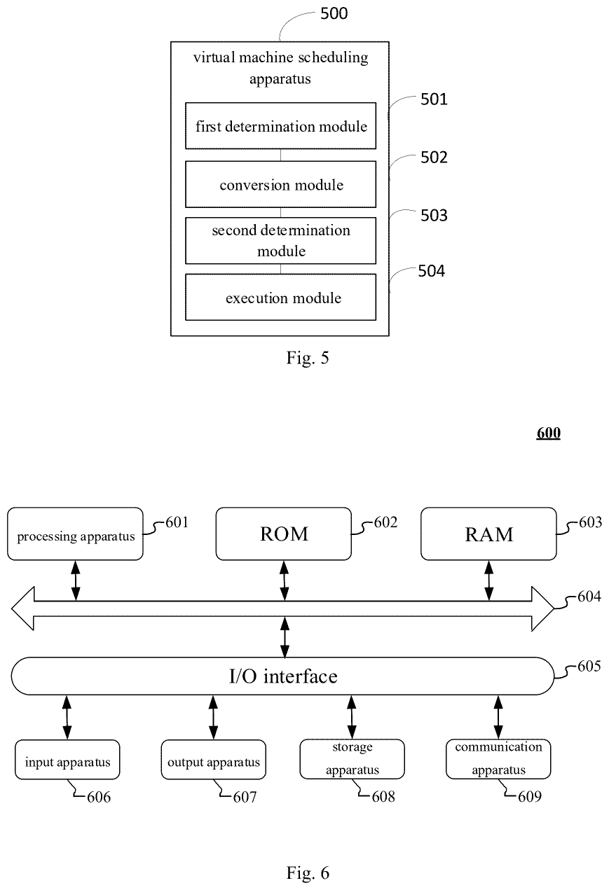

FIG. 5 is a structural diagram of a virtual machine scheduling apparatus according to an exemplary embodiment. As shown in FIG. 5, an embodiment of the present disclosure provides a virtual machine scheduling apparatus 500, the virtual machine scheduling apparatus 500 includes:
a first determination module 501, configured to determine resource information of a target virtual machine and a target physical machine indicated by a virtual machine scheduling requirement in response to the virtual machine scheduling requirement;
a conversion module 502, configured to convert the virtual machine scheduling requirement into a target constraint condition of the target virtual machine and the target physical machine under a basic scheduling algorithm according to a conversion rule that is pre-configured, where the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirements, virtual machine migration paths corresponding to virtual machine scheduling requirements, and the conversion rule is generated based on a historical virtual machine scheduling requirement and is used to convert different types of virtual machine scheduling requirements into different constraint conditions;
a second determination module 503, configured to determine a target virtual machine migration path corresponding to the virtual machine scheduling requirement according to the target constraint condition, the resource information of the target virtual machine and the target physical machine, and the basic scheduling algorithm;
an execution module 504, configured to perform virtual machine scheduling according to the target virtual machine migration path.

Optionally, the target constraint condition includes at least one of a first affinity coefficient or a second affinity coefficient, the first affinity coefficient being used to represent magnitude of an affinity relationship between virtual machines, and the second affinity coefficient being used to represent magnitude of an affinity relationship between a virtual machine and a physical machine.

The second determination module 503 is further configured to:
determine the target virtual machine migration path that meets a scheduling objective corresponding to the basic scheduling algorithm according to the target constraint condition, the resource information, and the basic scheduling algorithm, where the scheduling objective is to minimize a sum of affinity coefficients corresponding to the target virtual machine migration path.

Optionally, the target constraint condition further includes at least one of the followings:
a mutual exclusion relationship between the target virtual machines;
a mutual exclusion relationship between the target virtual machine and the target physical machine, where the mutual exclusion relationship is used to indicate that the basic scheduling algorithm excludes a virtual machine migration path with the mutual exclusion relationship;
an attribute type of the target virtual machine and an attribute type of the target physical machine, where the attribute types are used to indicate that the basic scheduling algorithm selects a virtual machine migration path where the target virtual machine and the target physical machine both having consistent attribute types are deployed together as the target virtual machine migration path; or
a scheduling overhead of the target virtual machine and a scheduling overhead of the target physical machine, where the scheduling overhead is used to indicate that the basic scheduling algorithm determines the target virtual machine migration path that meets minimizing the scheduling objective corresponding to the basic scheduling algorithm, and the scheduling objective is to minimize the sum of the scheduling overheads of the target virtual machine migration path and to minimize the sum of the affinity coefficients of the target virtual machine migration path.

Optionally, the conversion rule includes different matching conditions and constraint conditions associated with the matching conditions, the matching condition is determined according to a parameter included in the historical virtual machine scheduling requirement, and the constraint condition associated with the matching condition are determined according to a scheduling objective corresponding to the historical virtual machine scheduling requirement.

The conversion module 502 is further configured to:
match the target parameter included in the virtual machine scheduling requirement through the different matching conditions, and determine the constraint condition associated with the target matching condition as the target constraint condition according to the target matching condition matched to the target parameter, where the target parameter includes a parameter used to describe the migration manner of the target virtual machine.

Optionally, the virtual machine scheduling apparatus 500 further includes:
a configuration module, configured to configure the virtual machine scheduling requirement through a configuration channel that is provided, where the configuration channel supports the user to configure the virtual machine scheduling requirement through a number of configuration manners including parameter configuration, option configuration, semantic configuration, or visual configuration.

Optionally, the first determination module 501 is further configured to:
create a test virtual machine and a test physical machine matching with a target number indicated by the virtual machine scheduling requirement according to the virtual machine scheduling requirement;
configure corresponding resource information for the test virtual machine and the test physical machine according to the virtual machine scheduling requirement; and
   use the resource information of the test virtual machine and the test physical machine as the resource information of the target virtual machine and the target physical machine indicated by the virtual machine scheduling requirement.

Optionally, the execution module 504 is further configured to:
according to the target virtual machine migration path, predict a service indicator of a cloud service system corresponding to the target virtual machine when the target virtual machine migration path is executed; and
perform the virtual machine scheduling according to the target virtual machine migration path in case that the service indicator meets a preset condition.

Regarding the logic of the methods executed by the respective functional modules in the virtual machine scheduling apparatus 500, reference may be made to the parts related to the methods in the above embodiments, which will not be repeated here.

Referring to FIG. 6 below, it illustrates a structural diagram of an electronic device (for example, a terminal device or a server) 600 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable multimedia player (PMP), and an in-vehicle terminal (such as an in-vehicle navigation terminal), and stationary terminals such as a digital TV and a desktop computer. The electronic device shown in FIG. 6 is only an example, and should not impose any limitation to the functions and the range of use of the embodiments of the present disclosure.

As shown in FIG. 6, the electronic device 600 may include a processing apparatus (such as a central processing unit, a graphics processor, etc.) 601, which may perform various suitable actions and processing according to a program stored in a read-only memory (ROM) 602 or a program loaded from a storage apparatus 608 into a random-access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 such as a touch screen, a touchpad, a keyboard, a mouse, a camera, a microphone, an accelerometer, a gyroscope, or the like; an output apparatus 607 such as a liquid crystal display (LCD), a speaker, a vibrator, or the like; a storage apparatus 608 such as a magnetic tape, a hard disk, or the like; and a communication apparatus 609. The communication apparatus 609 may allow the electronic device 600 to perform wireless or wired communication with other devices to exchange data. Although FIG. 6 shows the electronic device 600 having various apparatuses, it should be understood that not all of the illustrated apparatuses are necessarily implemented or included. Alternatively, more or fewer apparatuses may be implemented or included.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, where the computer program includes program codes for executing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus or device. In the present disclosure, the computer-readable signal medium may include a data signal propagated in a baseband or as a part of a carrier wave, in which computer-readable program codes are carried. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus or device. The program codes contained on the computer-readable medium may be transmitted by any suitable medium, including but not limited to an electrical wire, an optical cable, radio frequency (RF), etc., or any suitable combination thereof.

In some implementations, the electronic device may communicate using any currently known or future developed network protocol, such as the Hypertext transfer protocol (HTTP), and may be interconnected with digital data in any form or medium (for example, a communication network). Examples of the communication network include a local area network (“LAN”), a wide area network (“WAN”), an internet (for example, the Internet), and a peer-to-peer network (for example, an ad hoc peer-to-peer network), as well as any currently known or future developed network.

The above computer-readable medium may be included in the above electronic device; or may also exist alone without being assembled into the electronic device.

The above computer-readable medium carries one or more programs, and when the above one or more programs are executed by the electronic device, the electronic device is caused to: determine resource information of a target virtual machine and a target physical machine indicated by a virtual machine scheduling requirement in response to the virtual machine scheduling requirement; convert the virtual machine scheduling requirement into a target constraint condition of the target virtual machine and the target physical machine under a basic scheduling algorithm according to a conversion rule that is pre-configured, where the basic scheduling algorithm is decoupled from a virtual machine scheduling requirement generated at a service side and is used to support virtual machine scheduling requirements of respective services at an upper layer and determine, in conjunction with constraint conditions corresponding to the virtual machine scheduling requirements, virtual machine migration paths corresponding to the virtual machine scheduling requirements, and the conversion rule is generated based on a historical virtual machine scheduling requirement and is used to convert different types of virtual machine scheduling requirements into different constraint conditions; determine a target virtual machine migration path corresponding to the virtual machine scheduling requirement according to the target constraint condition, the resource information of the target virtual machine and the target physical machine, and the basic scheduling algorithm; and perform virtual machine scheduling according to the target virtual machine migration path.

The computer program codes for performing the operations of the present disclosure may be written in one or more programming languages or a combination thereof, where the foregoing programming languages include object-oriented programming languages such as Java, Smalltalk, C++, and also include conventional procedural programming languages such as the “C” programming language or similar programming languages. The program codes may be executed entirely on a user computer, executed partly on a user computer, executed as a stand-alone software package, executed partly on a user computer and partly on a remote computer, or executed entirely on a remote computer or a server. In the scenario involving the remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functions, and operations of possible implementations of the systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions noted in the blocks may also be implemented in an order different from the order noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. The name of the module does not constitute a limitation of the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine readable medium may be a tangible medium that may contain or store a program for use by or in combination with an instruction execution system, apparatus, or device. The machine readable medium may be a machine readable signal medium or a machine readable storage medium. The machine readable medium may include, but is not limited to, an electrical, magnetic, optical, electromagnetic, infrared, or semiconductor system, apparatus, or device, or any suitable combination of the foregoing. More specific examples of the machine readable storage medium may include an electrical connection having one or more wires, a portable computer diskette, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the foregoing.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalents. For example, a technical solution formed by replacing the above features with technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are only example forms for implementing the claims. Regarding the apparatus in the above embodiments, the specific manners in which the respective modules perform the operations have been described in detail in the method embodiments, and will not be described in detail here.

1. A virtual machine scheduling method, comprising:
determining resource information of a target virtual machine and a target physical machine indicated by a virtual machine scheduling requirement in response to the virtual machine scheduling requirement;
converting the virtual machine scheduling requirement into a target constraint condition of the target virtual machine and the target physical machine under a basic scheduling algorithm according to a conversion rule that is pre-configured, wherein the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirements, virtual machine migration paths corresponding to the virtual machine scheduling requirements, and the conversion rule is generated based on a historical virtual machine scheduling requirement and is used to convert different types of virtual machine scheduling requirements into different constraint conditions;
determining a target virtual machine migration path corresponding to the virtual machine scheduling requirement according to the target constraint condition, the resource information of the target virtual machine and the target physical machine, and the basic scheduling algorithm; and
performing virtual machine scheduling according to the target virtual machine migration path.

2. The method according to claim 1, wherein the target constraint condition comprises at least one of a first affinity coefficient or a second affinity coefficient, the first affinity coefficient is used to represent magnitude of an affinity relationship between virtual machines, and the second affinity coefficient is used to represent magnitude of an affinity relationship between a virtual machine and a physical machine; and
determining the target virtual machine migration path corresponding to the virtual machine scheduling requirement according to the target constraint condition, the resource information of the target virtual machine and the target physical machine, and the basic scheduling algorithm comprises:
determining the target virtual machine migration path that meets a scheduling objective corresponding to the basic scheduling algorithm according to the target constraint condition, the resource information, and the basic scheduling algorithm, wherein the scheduling objective is to minimize a sum of affinity coefficients corresponding to the target virtual machine migration path.

3. The method according to claim 1, wherein the target constraint condition comprises at least one of followings:
a mutual exclusion relationship between target virtual machines;
a mutual exclusion relationship between the target virtual machine and the target physical machine, wherein the mutual exclusion relationship is used to indicate that the basic scheduling algorithm excludes a virtual machine migration path with the mutual exclusion relationship;
an attribute type of the target virtual machine and an attribute type of the target physical machine, wherein the attribute type is used to indicate that the basic scheduling algorithm selects a virtual machine migration path wherein the target virtual machine and the target physical machine both having consistent attribute types are deployed together as the target virtual machine migration path; or
a scheduling overhead of the target virtual machine and a scheduling overhead of the target physical machine, wherein the scheduling overhead is used to indicate that the basic scheduling algorithm determines the target virtual machine migration path that meets minimizing the scheduling objective corresponding to the basic scheduling algorithm, and the scheduling objective is to minimize a sum of scheduling overheads of the target virtual machine migration path and to minimize the sum of the affinity coefficients of the target virtual machine migration path.

4. The method according to claim 1, wherein the conversion rule comprises different matching conditions and constraint conditions associated with the matching conditions, a matching condition is determined according to a parameter comprised in a historical virtual machine scheduling requirement, and a constraint condition associated with the matching condition is determined according to a scheduling objective corresponding to the historical virtual machine scheduling requirement; and
converting the virtual machine scheduling requirement into the target constraint condition of the target virtual machine and the target physical machine under the basic scheduling algorithm according to the conversion rule that is pre-configured comprises:
matching a target parameter comprised in the virtual machine scheduling requirement through the different matching conditions, and determining a constraint condition associated with a target matching condition as the target constraint condition according to the target matching condition matched to the target parameter, wherein the target parameter comprises a parameter used to describe a migration manner of the target virtual machine.

5. The method according to claim 4, wherein the virtual machine scheduling requirement is obtained by a following step:
configuring the virtual machine scheduling requirement through a configuration channel that is provided, wherein the configuration channel supports a user to configure the virtual machine scheduling requirement through a number of configuration manners including parameter configuration, option configuration, semantic configuration, or visual configuration.

6. The method according to claim 1, wherein determining the resource information of the target virtual machine and the target physical machine indicated by the virtual machine scheduling requirement in response to the virtual machine scheduling requirement comprises:
creating a test virtual machine and a test physical machine matching with a target number indicated by the virtual machine scheduling requirement according to the virtual machine scheduling requirement;
configuring corresponding resource information for the test virtual machine and the test physical machine according to the virtual machine scheduling requirement; and
using the resource information of the test virtual machine and the test physical machine as the resource information of the target virtual machine and the target physical machine indicated by the virtual machine scheduling requirement.

7. The method according to claim 1, wherein performing the virtual machine scheduling according to the target virtual machine migration path comprises:
according to the target virtual machine migration path, predicting a service indicator of a cloud service system corresponding to the target virtual machine when the target virtual machine migration path is executed; and
performing the virtual machine scheduling according to the target virtual machine migration path in case that the service indicator meets a preset condition.

8. A non-transitory computer-readable medium having a computer program stored thereon, wherein when the computer program is executed by a processing apparatus, a virtual machine scheduling method is implemented, and the virtual machine scheduling method comprises:
determining resource information of a target virtual machine and a target physical machine indicated by a virtual machine scheduling requirement in response to the virtual machine scheduling requirement;
converting the virtual machine scheduling requirement into a target constraint condition of the target virtual machine and the target physical machine under a basic scheduling algorithm according to a conversion rule that is pre-configured, wherein the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirement, virtual machine migration paths corresponding to the virtual machine scheduling requirement, and the conversion rule is generated based on a historical virtual machine scheduling requirement and is used to convert different types of virtual machine scheduling requirements into different constraint conditions;
determining a target virtual machine migration path corresponding to the virtual machine scheduling requirement according to the target constraint condition, the resource information of the target virtual machine and the target physical machine, and the basic scheduling algorithm; and
performing virtual machine scheduling according to the target virtual machine migration path.

9. The non-transitory computer-readable medium according to claim 8, wherein the target constraint condition comprises at least one of a first affinity coefficient or a second affinity coefficient, the first affinity coefficient is used to represent magnitude of an affinity relationship between virtual machines, and the second affinity coefficient is used to represent magnitude of an affinity relationship between a virtual machine and a physical machine; and
determining the target virtual machine migration path corresponding to the virtual machine scheduling requirement according to the target constraint condition, the resource information of the target virtual machine and the target physical machine, and the basic scheduling algorithm comprises:
determining the target virtual machine migration path that meets a scheduling objective corresponding to the basic scheduling algorithm according to the target constraint condition, the resource information, and the basic scheduling algorithm, wherein the scheduling objective is to minimize a sum of affinity coefficients corresponding to the target virtual machine migration path.

10. The non-transitory computer-readable medium according to claim 8, wherein the conversion rule comprises different matching conditions and constraint conditions associated with the matching conditions, a matching condition is determined according to a parameter comprised in a historical virtual machine scheduling requirement, and a constraint condition associated with the matching condition is determined according to a scheduling objective corresponding to the historical virtual machine scheduling requirement; and
converting the virtual machine scheduling requirement into the target constraint condition of the target virtual machine and the target physical machine under the basic scheduling algorithm according to the conversion rule that is pre-configured comprises:
matching a target parameter comprised in the virtual machine scheduling requirement through the different matching conditions, and determining a constraint condition associated with a target matching condition as the target constraint condition according to the target matching condition matched to the target parameter, wherein the target parameter comprises a parameter used to describe a migration manner of the target virtual machine.

11. The non-transitory computer-readable medium according to claim 10, wherein the virtual machine scheduling requirement is obtained by a following step:
configuring the virtual machine scheduling requirement through a configuration channel that is provided, wherein the configuration channel supports a user to configure the virtual machine scheduling requirement through a number of configuration manners including parameter configuration, option configuration, semantic configuration, or visual configuration.

12. The non-transitory computer-readable medium according to claim 8, wherein determining resource information of the target virtual machine and the target physical machine indicated by the virtual machine scheduling requirement in response to the virtual machine scheduling requirement comprises:
creating a test virtual machine and a test physical machine matching with a target number indicated by the virtual machine scheduling requirement according to the virtual machine scheduling requirement;
configuring corresponding resource information for the test virtual machine and the test physical machine according to the virtual machine scheduling requirement; and
using the resource information of the test virtual machine and the test physical machine as the resource information of the target virtual machine and the target physical machine indicated by the virtual machine scheduling requirement.

13. The non-transitory computer-readable medium according to claim 8, wherein performing the virtual machine scheduling according to the target virtual machine migration path comprises:
according to the target virtual machine migration path, predicting a service indicator of a cloud service system corresponding to the target virtual machine when the target virtual machine migration path is executed; and
performing the virtual machine scheduling according to the target virtual machine migration path in case that the service indicator meets a preset condition.

14. An electronic device, comprising:
a storage apparatus having a computer program stored thereon; and
a processing apparatus, configured to execute the computer program in the storage apparatus to implement a virtual machine scheduling method, wherein the virtual machine scheduling method comprises:
determining resource information of a target virtual machine and a target physical machine indicated by a virtual machine scheduling requirement in response to the virtual machine scheduling requirement;
converting the virtual machine scheduling requirement into a target constraint condition of the target virtual machine and the target physical machine under a basic scheduling algorithm according to a conversion rule that is pre-configured, wherein the basic scheduling algorithm is decoupled from a virtual machine scheduling requirement generated at a service side and is used to support virtual machine scheduling requirements of respective services at an upper layer and determine, in conjunction with constraint conditions corresponding to respective virtual machine scheduling requirement, virtual machine migration paths corresponding to the virtual machine scheduling requirement, and the conversion rule is generated based on a historical virtual machine scheduling requirement and is used to convert different types of virtual machine scheduling requirements into different constraint conditions;
determining a target virtual machine migration path corresponding to the virtual machine scheduling requirement according to the target constraint condition, the resource information of the target virtual machine and the target physical machine, and the basic scheduling algorithm; and
performing virtual machine scheduling according to the target virtual machine migration path.

15. The electronic device according to claim 14, wherein the target constraint condition comprises at least one of a first affinity coefficient or a second affinity coefficient, the first affinity coefficient is used to represent magnitude of an affinity relationship between virtual machines, and the second affinity coefficient is used to represent magnitude of an affinity relationship between a virtual machine and a physical machine; and
determining the target virtual machine migration path corresponding to the virtual machine scheduling requirement according to the target constraint condition, the resource information of the target virtual machine and the target physical machine, and the basic scheduling algorithm comprises:
determining the target virtual machine migration path that meets a scheduling objective corresponding to the basic scheduling algorithm according to the target constraint condition, the resource information, and the basic scheduling algorithm, wherein the scheduling objective is to minimize a sum of affinity coefficients corresponding to the target virtual machine migration path.

16. The electronic device according to claim 14, wherein the conversion rule comprises different matching conditions and constraint conditions associated with the matching conditions, a matching condition is determined according to a parameter comprised in a historical virtual machine scheduling requirement, and a constraint condition associated with the matching condition is determined according to a scheduling objective corresponding to the historical virtual machine scheduling requirement; and
converting the virtual machine scheduling requirement into the target constraint condition of the target virtual machine and the target physical machine under the basic scheduling algorithm according to the conversion rule that is pre-configured comprises:
matching a target parameter comprised in the virtual machine scheduling requirement through the different matching conditions, and determining a constraint condition associated with a target matching condition as the target constraint condition according to the target matching condition matched to the target parameter, wherein the target parameter comprises a parameter used to describe a migration manner of the target virtual machine.

17. The electronic device according to claim 16, wherein the virtual machine scheduling requirement is obtained by a following step:
configuring the virtual machine scheduling requirement through a configuration channel that is provided, wherein the configuration channel supports a user to configure the virtual machine scheduling requirement through a number of configuration manners including parameter configuration, option configuration, semantic configuration, or visual configuration.

18. The electronic device according to claim 14, wherein determining resource information of the target virtual machine and the target physical machine indicated by the virtual machine scheduling requirement in response to the virtual machine scheduling requirement comprises:
creating a test virtual machine and a test physical machine matching with a target number indicated by the virtual machine scheduling requirement according to the virtual machine scheduling requirement;
configuring corresponding resource information for the test virtual machine and the test physical machine according to the virtual machine scheduling requirement; and
using the resource information of the test virtual machine and the test physical machine as the resource information of the target virtual machine and the target physical machine indicated by the virtual machine scheduling requirement.

19. The electronic device according to claim 14, wherein performing the virtual machine scheduling according to the target virtual machine migration path comprises:
according to the target virtual machine migration path, predicting a service indicator of a cloud service system corresponding to the target virtual machine when the target virtual machine migration path is executed; and
performing the virtual machine scheduling according to the target virtual machine migration path in case that the service indicator meets a preset condition.

20. The electronic device according to claim 14, wherein the target constraint condition comprises at least one of followings:
a mutual exclusion relationship between target virtual machines;
a mutual exclusion relationship between the target virtual machine and the target physical machine, wherein the mutual exclusion relationship is used to indicate that the basic scheduling algorithm excludes a virtual machine migration path with the mutual exclusion relationship;
an attribute type of the target virtual machine and an attribute type of the target physical machine, wherein the attribute type is used to indicate that the basic scheduling algorithm selects a virtual machine migration path wherein the target virtual machine and the target physical machine both having consistent attribute types are deployed together as the target virtual machine migration path; or
a scheduling overhead of the target virtual machine and a scheduling overhead of the target physical machine, wherein the scheduling overhead is used to indicate that the basic scheduling algorithm determines the target virtual machine migration path that meets minimizing the scheduling objective corresponding to the basic scheduling algorithm, and the scheduling objective is to minimize a sum of the scheduling overheads of the target virtual machine migration path and to minimize the sum of the affinity coefficients of the target virtual machine migration path.
